(19) United States
(12) Patent Application Publication
(10) Pub. No.: US 2016/0077723 A1
(43) Pub. Date: Mar. 17, 2016

(54) DYNAMIC ADAPTATION OF INTERACTIVE INFORMATION CONTAINERS' CONTENT AND STATE

(71) Applicant: REALITYGATE (PTY) LTD., Stellenbosch (ZA)

(72) Inventors: Jan Pool, Stellenbosch (ZA); Adri Smuts, Durbanville (ZA); Willem Morkel Van Der Westhuizen, Stellenbosch (ZA); Hendrik Frans Verwoerd Boshoff, Stellenbosch (ZA)

(21) Appl. No.: 14/787,462

(22) PCT Filed: May 12, 2014
(86) PCT No.: PCT/IB2014/001818

§ 371 Date: Oct. 27, 2015

Related U.S. Application Data
(60) Provisional application No. 61/822,868, filed on May 13, 2013.

(51) Int. Cl. G06F 3/0484; H04L 12/58; G06F 17/21

(52) U.S. Cl. CPC G06F 3/04847; G06F 17/212; H04L 51/32

(57) ABSTRACT

A user input position of a user input received from an input device of the electronic device is determined and a direction of motion of the user input based on one or more previously-received user input positions. A plurality of adaptable interactive elements are presented via the display and a changeable set of adaptable interactive elements is determined in response to the received user input position. The changeable set of adaptable interactive elements is determined by interpreting one or more of the user input position and the direction of motion of the user input in relation to positions in which each of the plurality of adaptable interactive elements are presented and contextual relationships between the adaptable interactive elements. One or more of the adaptable interactive elements in the determined changeable are modified set in response to the received user input.

### CROSS REFERENCE TO RELATED APPLICATIONS

This application claims the benefit of U.S. Provisional Application No. 61/822,868, filed May 13, 2014, which is incorporated by reference in its entirety.

### BACKGROUND

This invention generally relates to a method for human-computer interaction on a user interface to navigate and select interactive multimedia content

Electronic devices are often used to find information about products or services and to consume media. This provides product and service producers with an opportunity to call a consumer's attention to their offerings.

Producers would like consumers to be apprised of their offerings, while consumers would like to find relevant products and services quickly when the need arises. The state of the art in marketing, advertising, searching and recommender systems continually evolves to match producers and consumers more effectively.

Producers, or third party intermediaries, already collect large quantities of consumer data. This includes consumer behavior, tastes, interests, geographic location and social graph. This a priori data may be used to provide customized and targeted information, for example search results, advertising or recommendations, to a specific consumer or market segment (a collection of consumers with a similar need).

The targeted information presented to a consumer is often static or offer limited interactive capability. Furthermore, providers of promotional content do not know whether or not a consumer is interested in the presented information until a selection is made. For example, the relevance and effectiveness of the targeted information is typically inferred from the selections that a consumer does or does not make.

In cases where the primary information the consumer is after is not product or service information, one would prefer not to take up too much display space on a device to insert contextual advertisements that the consumer may or may not be interested in. This is especially true for small screen devices, such as phones. The smaller form factor devices pose a challenge to advertisers, since a lower number of advertisements can be practically displayed and any space taken up by an advertisement is space that cannot be used for application functionality.

Advertisements in printed media are static and usually a mixture of images and text. Radio advertisements are audio, while television advertisements employ text, images, audio and video. Online, smart television and mobile application platforms offer opportunities for creating advertisements that are richer in media and more interactive. Early online platforms offered mostly static text and images in the form of banner advertisements, these evolved to include animations. Some providers of promotional content opted to rather show less distracting and simplified text advertisements. However, video sites often insert traditional TV-like advertisement before displaying videos or show banner-like advertisements that pop up after a few seconds of playback. On mobile platforms, advertisers also started out with banner-like advertisements, but these have evolved to be more interactive and media rich. Mobile platforms provide interactive advertisements that are incorporated in mobile applications. Typically, static advertisements are interleaved with non-promotional content. When a user of the system selects an advert, a browser may be opened automatically to display more information, alternatively a window may take over most of the screen. The standalone window may then provide a microsite with social integration, contact, location, commerce and other interactive features. These adverts still take up a sizable portion of the display at all times. Alternatively, an advertisement is displayed on a home screen and when selected, additional text, images and videos may be displayed.

### SUMMARY

Disclosed is a method for interacting with content on an electronic device that consists of at least a graphical display, a means of position based input and computational ability. The method supports a variety of display form factors and qualities. Examples include displays for watches, music players, phones, tablets, laptops, desktops and televisions. The method requires a means of user-controlled input that provides sufficiently accurate multi-dimensional position coordinates in one or more reference coordinate systems. Exemplary input devices include computer mice, touchpads, joysticks, multi-touch surfaces, tracked gloves and three-dimensional (3D) input devices. The method may use relative or absolute input mechanisms. Position based input is tracked and recorded as one or more trajectories. A user of the system is a consumer of content or a consumer interested in finding and/or using a product or service.

An initial arrangement of multimedia content, such as a combination of text, audio, still images, videos, animations, hyperlinks or other interactive content forms, is presented to a user on the display of a controllable electronic computational device. The source, aggregation and layout of the presented content may be determined by previous user actions, for example opening a file, selecting music, playing a movie, showing images, opening webpages or submitting a search query online. The presented content may contain a combination of media the user explicitly requested and targeted media that may be of interest to the user. Typical examples are: an article that contains a mixture of topic relevant media along with consumer targeted promotional media; and a search query page that shows the search results and targeted advertisements. Statistical methods and a priori data (collected and processed at an earlier time) may be used to deliver targeted and contextually relevant promotional media to a specific user of the system.

The invention presents a method that continuously, fluidly and interactively emphasizes some of the presented content over other presented content, based on a user's indicated or inferred interest as signaled by means of the user controlling an input device. The method further allows for the adaptation of such content to increase relevant information flow to the user. Forms of adaption may include providing more space to some content on the screen, highlighting some portion of the content, progressively showing more detailed information, and showing information related to previous choices the user made. The invention also provides a means to track what content a user may be interested in, without the user performing a selection.

According to the invention, content is presented to the user as statically placed and sized elements or, preferably, as adaptable interactive elements (AIE). An adaptable interactive element, or an “interactive object,” is a content container with which a user may interact. The state of the container, as well as the container's content, may be adapted dynamically according to user interaction. The state of an adaptable interactive element may include its position in an interaction or display space, shape, dimensions, width-height aspect ratio, transparency, colors and visibility. The AIE may represent (render) any form of multimedia content. An AIE's content and the layout of the content, may additionally change based on the state of the AIE. An AIE container may host other AIE containers; we call this an AIE cluster (AIEC).

According to the invention, the user's control of the input device is tracked in a delineated interaction area and the sequence of generated position data is recorded. Activity outside of this area does not affect adaptation of the AIEs. Each time a change in input is detected within the interaction area, the user's interest degree-of-interest (DOI) in each AIE is inferred from the current and historic user inputs and actions. Any measure that determines interest may be used. The AIEs may then be adapted based on the inferred DOIs, upon which the displayed information will be updated. A continuously repeating loop of display, control and adaptation is attained, with the effect that a dynamic and fluid interface emerges.

One method in which AIEs with a higher DOI are emphasized, over those AIEs with a lower DOI, is by allocating more control and display space to the former group. This is achieved by increasing the overall space available to AIEs, and by redistributing space from the lower DOI elements to the higher DOI elements. AIEs that receive extra space may show additional, or more detailed, content or resize the content already shown, for example by increasing image and font sizes. AIEs that lose space may perform the inverse operations. As the dimensions and width-height aspect ratio of a container changes, the layout of the content may also adapt to better fit the container and to improve information transfer to the user.

In cases where the AIEs represent hierarchical content, the content may be distributed over multiple AIEs and may be packed in AIE cluster containers. Every AIE does not need to be visible all the time. For example, a first arrangement of parent and children AIEs may initially only show the set of parent containers and then, based on the user's interaction and the inferred DOIs, progressively reveal the children of high DOI AEIs.

In cases where the AIEs may be grouped into independent collections, where the collections may consist of AIEs with related subject matter, an algorithm may determine a first subset of AIEs to represent and lay out each collection in an initial arrangement of AIECs. Based on the user's interaction and the inferred DOIs, the method may progressively replace AIEs that represent less relevant subject matter, with more relevant AIEs from the same or similar high DOI collections.

Techniques for continuously and dynamically adapting interacting objects are disclosed in International Patent Application Publication No. WO/2013/049864, filed on Sep. 21, 2012, South African Provisional Patent Application ZAP/2012/09617 filed on Dec. 19, 2012, and South African Provisional Patent Application ZAP/2013/02285, filed on Mar. 12, 2013, each of which is hereby incorporated by reference in its entirety. For example, a direction of motion of an input with a device is continuously interpreted and used at a distance to dynamically change object properties, such as object size, position and associated thresholds. Additionally, a display and control space allocated to interactive objects is independently and repeatedly updated to provide a continuous trade-off between the rate of navigation and ease of acquisition of a set of objects. Memory is used to gain hysteretic effects. A joint interaction arena (JIA) may be used as a bounded connected subspace of the computing device's control space, along with a segmented threshold (ST) on the boundary of the JIA. The ST spatially represents information about associated interactive objects in its segments. Input is received and tracked in the JIA. The input is used to, among other things, change the ST boundary, the rules of interaction and the properties of associated interactive objects. AIE containers can be treated as interactive objects.

Responsive Web Design (RWD) offers a practical set of techniques to implement dynamic content layout across different size and aspect ratio form factors. RWD adapts a layout using proportion-based grids, variable image dimensions and CSS3 media queries. Proportional grid layouts use relative dimensional units, such as percentages, over absolute units, such as pixels. Images with different dimensions are generated on request to reduce image file size. Image display dimensions are also specified using relative units. Media queries allow a layout to use different cascading style sheet (CSS) style rules based on properties such as view or device width, height and width-height aspect ratios.

The size of an AIE container places constraints on types and an amount of information that can practically be displayed. A container that is extremely small, for example 32×32 pixels, is better suited to display icons, logos and low detail images. However, larger containers allow display of text, videos, multiple images or a mixture of media.

The invention disclosed herein reduces the amount of space used to present promotional content via a display device. Additionally, rapid and dynamic access may be provided to additional content in which a user may be interested by modifying or adapting an interactive object or AIE container. Further, if content is hierarchically organized, the present invention allows a user to navigate to and explore deeper levels of content than the displayed content without making explicit selections of content; navigation from deeper levels of a hierarchy to higher levels of the hierarchy is also simplified. If content is accessed from a source external to a client device via a network (e.g., retrieved from a web server or an application provider), the disclosed invention allows for navigation through content presented via the external source before explicitly directing the client device to retrieve information from the external source. For example, content from an external source is presented along with an interactive object presenting content from an alternative external source presented, and content from the additional external source presented in the interactive object is modified based on user input; this allows the user to view additional content from the additional external source before instructing the client device to present content from the additional external source in place of the content from the external source. Additionally, the disclosed invention allows content provisioning to be smoothly scaled over view, client device, and AIE container dimensions.

The disclosed invention also allows a content provider to receive information describing a measure of interest by a user of a client device for content provided by the content provider. This may provide the content provider with additional information about user preferences or interests, allowing the content provider to subsequently provide content with which the user is more likely to interact. Additionally, the disclosed invention enables a content provider to display alternative or additional content while a user is interacting with additional content provided to the user by the content provider.

To improve user interaction with content items, a method dynamically adapts one or more interactive visual elements on a display of an electronic device. The method includes steps of: determining a user input position of a user input received from an input device of the electronic device, recording a direction of motion of the user input based on one or more previously-received user input positions, presenting a plurality of adaptable interactive elements via the device of the electronic device and determining a changeable set of adaptable interactive elements in response to the received user input position. The changeable set of adaptable interactive elements is determined by interpreting one or more of the user input position and the direction of motion of the user input in relation to positions in which each of the plurality of adaptable interactive elements are presented via the display device and contextual relationships between the adaptable interactive elements. The method further modifies one or more of the adaptable interactive elements in the determined changeable set in response to the received user input to visually distinguish one or more of the adaptable interactive elements in the determined changeable set from other adaptable interactive elements in the plurality of adaptable interactive elements. One or more of the adaptable interactive elements in the determined changeable set may be modified by: changing a state of one or more of the adaptable interface elements in the determined changeable set, changing content displayed by one or more of the adaptable interface elements in the determined changeable set, changing an amount of content displayed by one or more of the adaptable interface elements in the determined changeable set, changing a layout of content displayed by one or more of the adaptable interface elements in the determined changeable set, and any combination thereof.

Additionally, determining the changeable set of adaptable interactive elements may include determining a degree of interest of the user in each of the plurality of adaptable interactive elements based at least in part on the user input position and the direction of motion of the user input, with the adaptable interactive elements in the changeable set based at least in part on the determined degrees of interest. Further, a degree of interest of the user in an adaptable interactive element in the determined changeable set may be modified based at least in part on the user's degree of interest in the adaptable interactive element.

The content displayed by an adaptable interactive element may be text data, audio data, image data, video data, hyperlinks, and any combination thereof. Additionally, an adaptable interactive element may display a single advertisement, a sequence of advertisements, or a hierarchy of advertisements. In some implementations, an adaptable interactive elements displays one or more of a catalogue of products, a media library, one or more media channels, and one or more application launchers. Further, an adaptable interactive element may display information associated with an online retailer, such as pricing information for an item, availability of the item, a request to purchase the item, a request to include the item in a list associated with the user by the online system, and information describing the item. Similarly, an adaptable interactive element may display one or more interface elements for communicating information to a social networking system; examples of information communicated to a social networking system include: an indication of preference for content displayed to the user, a request to post content displayed to the user to the social networking system, a request to share content displayed to the user with another user via the social networking system, and a request for the social networking system to associate information describing the content displayed to the user with a user profile maintained by the social networking system for the user. Further, the content presented by an adaptable interface element may be determined from prior interactions by the user with one or more adaptable interactive elements, previously received user inputs, the direction of motion of the user input, and content previously displayed to the user by the adaptable interactive element. Additionally, a priori consumer data may also be used when determining content presented by an adaptable interactive element.

An interaction zone for receiving user input may be located at any arbitrary position on the display. The interaction zone may be of any arbitrary initial size on the display. Additionally, cluster containers may be laid out in a vertical or horizontal orientation, or a combination of orientations.

The method may also establish a joint interaction arena (JIA) as a bounded connected subspace of the computing device's control space. The method also establishing a segmented threshold (ST) on the boundary of a JIA where a discrete action or change takes place when reached. The JIA and ST may change dynamically as the adaptable interactive elements are modified.

According to the invention, a method for dynamically adapting a plurality of interactive visual elements on the display of an electronic device, comprising the steps of:
receiving the user input position from an input device;
recording the user input trajectory based on the prior user input positions;
establishing a plurality of adaptable interactive elements of which at least two are displayed;
determining a changeable set of adaptable interactive elements the user is interested in, each time user input is received by interpreting:
the user input position and trajectory in relation to the position of the interactive elements, and
the contextual relationships between adaptable interactive elements;
modifying the adaptable interactive elements each time user input is received, to emphasize the set of elements the user is interested in, in one or more of the following ways:
changing the state of the elements,
changing the content displayed by the elements,
changing how much content is displayed by the elements, or
changing the layout of the content displayed by the elements.

The step of determining a changeable set of adaptable interactive elements the user is interested in, may include the step of inferring a degree-of-interest (DOI) for each adaptable interactive element, and using the DOI to determine which elements to display.

The step of adapting the adaptable interactive elements may include the step of using the inferred DOI for each adaptable interactive element as a parameter to adapt the interactive elements.

The content of the adaptable interactive element may be any form of multimedia content, such as any combination of text, audio, still images, videos, animations, hyperlinks or other interactive content forms.

The content of the adaptable interactive element may exhibit a single, sequence or hierarchy of advertisements, catalogue of products, a media library, media channels or application launchers.

The content of the adaptable interactive element is determined by a priori consumer data, and now importantly, previous user actions, the input trajectory and navigation and selection choices the user made during interaction.

The interaction zone may be located at any arbitrary position on the display.

The interaction zone may be of any arbitrary initial size on the display.

Cluster containers may be laid out in a vertical or horizontal orientation, or a combination of orientations.

The adaptable interactive element may incorporate e-commerce features, such as product or service price; stock availability; “Add to Cart”, “Check Out” or “Add to Wish-list” buttons or hyperlinks; ratings; reviews and discussion comments.

An adaptable interactive element may incorporate social features, such as sharing, sending, posting, “Tweeting”, “Liking”, “+1”, “Pinning” and “Digging”.

The method may include the step of establishing a joint interaction arena (JIA) as a bounded connected subspace of the computing device's control space.

The method may include the step of establishing a segmented threshold (ST) on the boundary of a JIA where a discrete action or change takes place when reached.

The JIA and ST may change dynamically as the adaptable interactive elements are adapted.

In an alternative embodiment, a plurality of interactive objects to a user at a plurality of different positions of a client device in a graphical user interface. A user input position on the graphical user interface associated with an input device of the client device is determined Based at least in part on the determined user input position and one or more previously determined user input positions on the graphical user interface a direction of motion of the user input position is determined. An interactive object from the plurality of interactive objects is selected based at least in part on the user input position and the direction of motion of the user input position. Display of the selected interactive object is modified to visually distinguish the selected interactive object from other interactive objects in the plurality of interactive objects.

Display of the selected interactive object may be modified by modifying content presented by the selected interactive object (e.g., increasing an amount of content presented by the selected interactive object, retrieving additional content from a source associated with the content presented by the selected interactive object and displaying the additional content via the selected interactive object), increasing a size of the selected interactive object relative to sizes of one or more other interactive objects in the plurality of interactive objects, or displaying the selected interactive object in a different position of the graphical user interface than a position in the graphical user interface in which the selected interactive object was previously displayed.

The interactive object from the plurality of interactive objects may be determined by determining degrees of interest of the user in one or more interactive objects from the plurality of interactive objects based at least in part on the user input position and the direction of motion of the user input position and selecting the interactive object from the plurality of interactive objects based at least in part on the determined degrees of interest.

### BRIEF DESCRIPTION OF THE DRAWINGS

FIG. 1 illustrates schematically a basic AIE cluster with an AIE container and AIE cluster arranged horizontally.

FIG. 2A illustrates a basic set of containers as displayed on a touch interface with clusters C₁, . . . , C₅ and pointer 40.

FIG. 2B illustrates horizontal (only) pointer movement and the display feedback regarding the current favored object 50.3.

FIG. 2C illustrates the expansion changes occurring inside the cluster container C as movement on the z-axis starts.

FIG. 2D illustrates the gain in control space for container C₃ and the changes occurring in its horizontally arranged container 50.3 and cluster C_{3.1}.

FIGS. 2E and 2F further illustrate the expansion of containers 50.3 and 50.3.2 as movement on the z-axis continues and the contents of cluster C_{3.1.2.1} is revealed.

FIGS. 2G and 2H illustrate the final expansion of container C_{3.1.2.1} until the pointer is touching the input device screen.

FIG. 3A shows an example of a cluster containing five clusters with unequal initial control space weights.

FIG. 3B illustrates the reduction in control space weight of objects surrounding the favored object, C₃.

FIGS. 3C to 3F further illustrate the distribution of control space weight as the pointer approaches the touch device, landing on the device in FIG. 3F.

FIG. 4A illustrates an exemplary user search with a hierarchical advertising structure displayed in the form of clusters on the right of the display.

FIGS. 4B to 4F further illustrates the expansion of the clusters as user interest is expressed in cluster C₁ until the contents of container 50.1.1.2 is fully expanded and legible in FIG. 4F.

FIG. 5A illustrates a basic set of AIE clusters C₃ arranged horizontally at the bottom of the display.

FIG. 5B illustrates the expansion of the AIE cluster C₂ as vertical pointer movement in the x-y plane occurred.

FIG. 5C shows the current favored cluster as downward movement on the z-axis starts.

FIG. 5D illustrates the gain in control space for AIE cluster C_{2.1.1} as movement on the z-axis continues.

FIG. 5E illustrates the continued increasing in proportional display size of AIE cluster C_{2.1.1} as movement on the z-axis continues, with AIE container 50.1.2.3 currently being indicated as the favored AIE container.

FIG. 5F illustrates further movement on the z-axis with the control weights of AIE clusters C₁ and C₃ now at 0.

FIG. 5G illustrates the final expanded state of AIE container 50.1.2.3 as the pointer 40 makes contact with the input device screen.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview

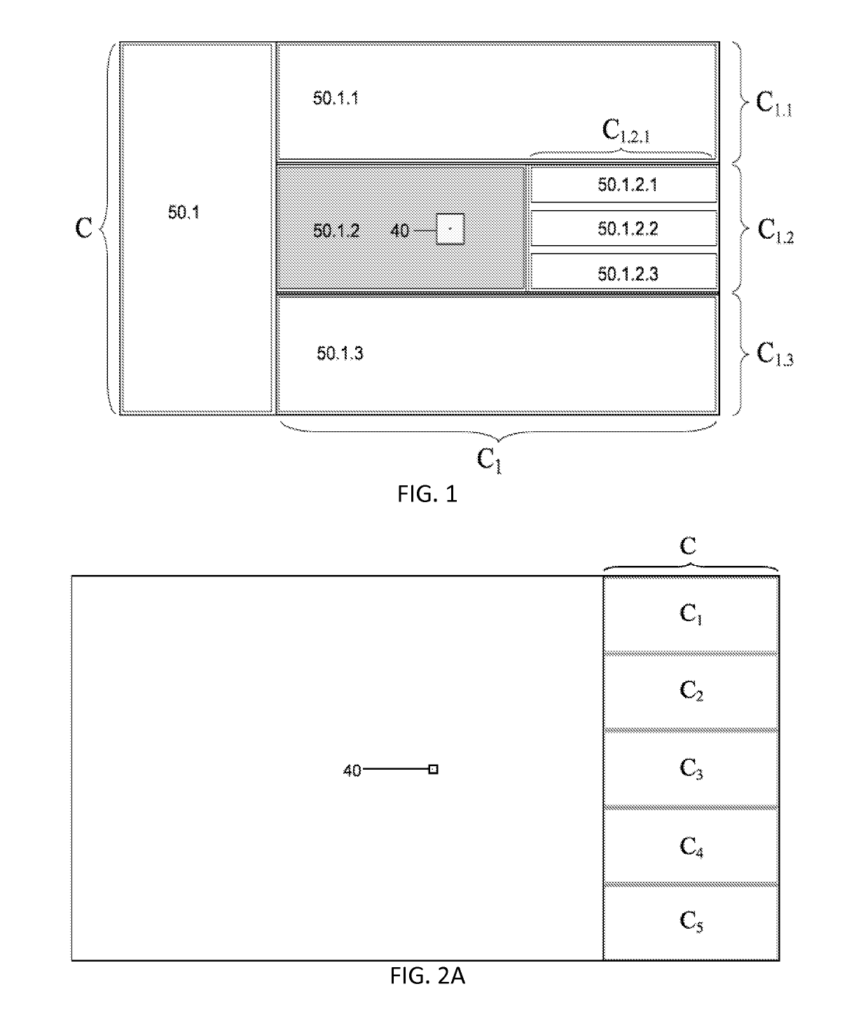

FIG. 1 illustrates the relationship between AIE containers within an AIE cluster C. In the text that follows, container is construed to mean AIE container and cluster is construed to mean AIE cluster container. The cluster C consists of the container 50.1 and the cluster C₁, arranged horizontally within C. Cluster C₁ then contains three vertically arranged clusters: C_{1.1}, C_{1.2}, and C_{1.3}. Each of the clusters consists of yet another container (e.g. 50.1.2) and another cluster (e.g. C_{1.2.1}), arranged horizontally, as displayed in container C_{1.2} of FIG. 1. The contents of clusters C_{1.1} and C_{1.3} are not expanded and therefore the full content is not visible. This may be due to a combination of a priori consumer data, the input trajectory and the navigation and selection choices made by the user. Since clusters C_{1.1} and C_{1.3} are not expanded, only the content of the first container of each cluster, 50.1.1 and 50.1.3, respectively, are displayed. Cluster C_{1.2}, is expanded to display both its container 50.1.2 and its cluster, C_{1.2.1}, consisting of vertically arranged containers 50.1.2.1-3. The pointer 40 shows that container 50.1.2 is the currently favored object due to its proximity to the pointer in the x-y plane. The container closest to the pointer in the x-y plane will always be considered the favored or preferred object in a 3D input configuration. While the following examples describe distance regarding the z-axis, in various embodiments, distances may be determined along any suitable axis. The 3D examples described herein may also be applied to 2D embodiments as well.

Each container within any cluster is initialized with a control weight, cᵢ, that may be based on a priori information. The control weight of an object is a non-negative number no larger than the maximum control weight, mᵢ, which may also defined per container i. The non-negative maximum control weight, mᵢ, may not have a value larger than 1. The control weight of a container is employed to proportionately allocate control, and subsequently display space, to the containers within a cluster.

A change in user pointer position relative to the input device may cause the control weights to change, resulting in a differently proportioned arrangement of control and display space. More specifically, it is the distance of the user pointer to the surface of the input device, which may trigger the change. This distance is represented by the z-axis of the coordinate system used to track pointer movement. The furthest point that is within range of the input device has a value of 1 and a point directly on the surface of the touch device, has a value of 0 with all other z values distributed uniformly between 0 and 1. For each iteration of the algorithm, triggered by a change in pointer position, more specifically a change in z, a global reduction function vₚ is used to determine the reduction in total control claim. Should the pointer enter the interaction area with an initial z value, z₀, of less than 1, the function is scaled accordingly. This situation typically occurs when the interaction area is entered from the side. Let zₚ denote the current z value of the pointer, then the global reduction function may be defined as:

vₚ=vₚ+(z₀−zₚ)e^{z}^{ₚ}. (1)

Any calculated vₚ with a negative value, is set to 0 and any calculated vₚ with a value greater than 1 is assigned a value of 1.

Based on this global reduction, a global counter relation Mₚ(vₚ) is introduced and may be calculated as:

$$\begin{matrix}{M}_{p} ( {v}_{p} ) = ( {m}_{s} - {m}_{t} ) {v}_{p} + {m}_{t} , \\ where & ( 2.1 ) \\ {m}_{t} = {\sum }_{i = 1}^{N} {m}_{i} , \\ and & ( 2.2 ) \\ {m}_{s} = min \{ {m}_{1} … {m}_{N} \} . & ( 2.3 )\end{matrix}$$

This ensures that Mₚ does not have a value less than the smallest maximum claim within the cluster, mₛ, and never more than the total of all maximum claims, mₜ. In the case where all initial claims (and therefore maximum claims) were initialized with a value of 1, the calculated Mₚ will be limited to the interval of [1 . . . N] for N containers.

The algorithm for adapting control weights proceeds as follows. Control weights, cᵢ, are assumed initialized, and the previous value of Mₚ is stored, starting with its maximum value of mₜ. Whenever the user input position changes, the corresponding vₚ and Mₚ values are calculated. The change in global count, ΔMₚ, should then be allocated to the control weights cᵢ.

The container closest to the current pointer coordinate in the x-y plane, experiences no intentional reduction in control claim. Depending on the exact method of reductions, the object or objects furthest from the pointer in the x-y plane may experience total or partial reductions in control claim, cᵢ. Methods may include, selecting the single object furthest from the current pointer position in the x-y plane or selecting the one or two objects that are sequentially the furthest from the current favored object, the latter resulting in a more balanced reduction in control claim. Another method, which may be used in combination with either of the above-mentioned methods, is to spread the total control weight, or a part thereof, equally over all objects other than the favored object. If the control weight is allocated partially, the remaining control weights should still be allocated using one of the first mentioned methods.

If the global count change ΔMₚ is negative, control claims of the furthest object(s) are reduced to the point where the combined reduction in control weights matches the negative global count change. The minimum control weight of any object is zero, so the sum of all remaining control weights should equal the value of Mₚ at all times.

If the global count change ΔMₚ is positive, control weights around the focus object 50.i are increased up to the maximum value of each, until the increase matches the global count change.

The new control weights cᵢ are used as before during the initialization steps to proportionately allocate control space to the objects.

In some embodiments the control space of containers in a cluster consisting of a parent container along with a cluster of child containers may be modified to provide an improved visual and interaction experience. For example, if the containing cluster's width is less than a certain size, only show the parent container, and if the containing cluster's width is larger than a certain size, only show the child container. One way to achieve this effect is by weighing the control weights of the parent and child containers as a function of the containing cluster's width.

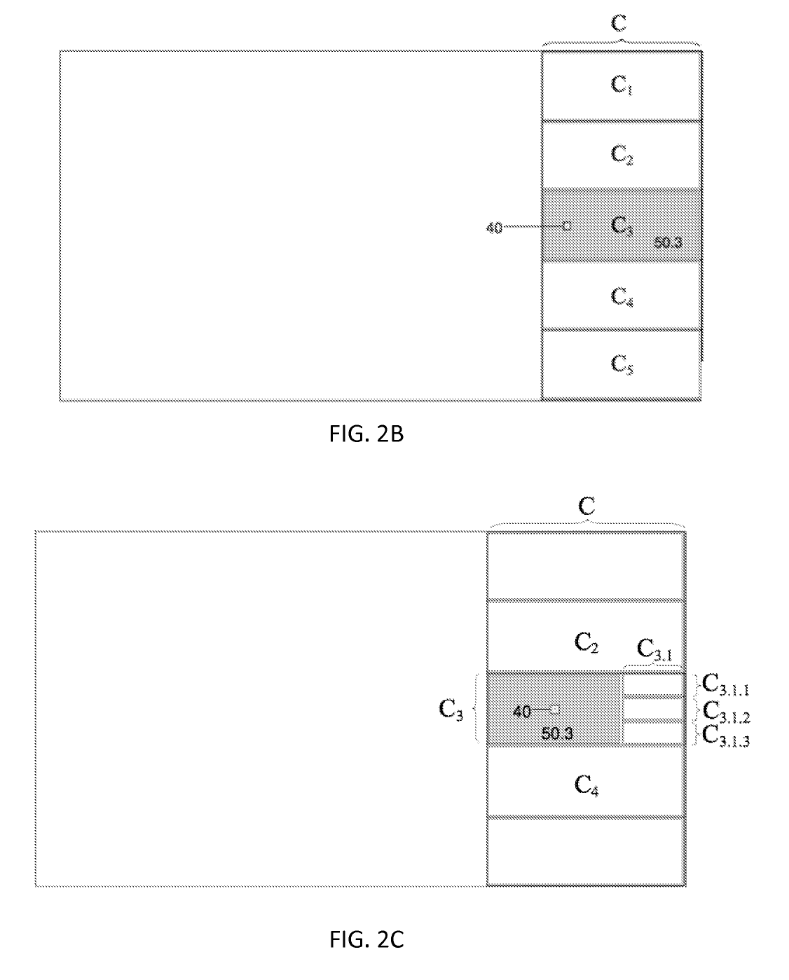

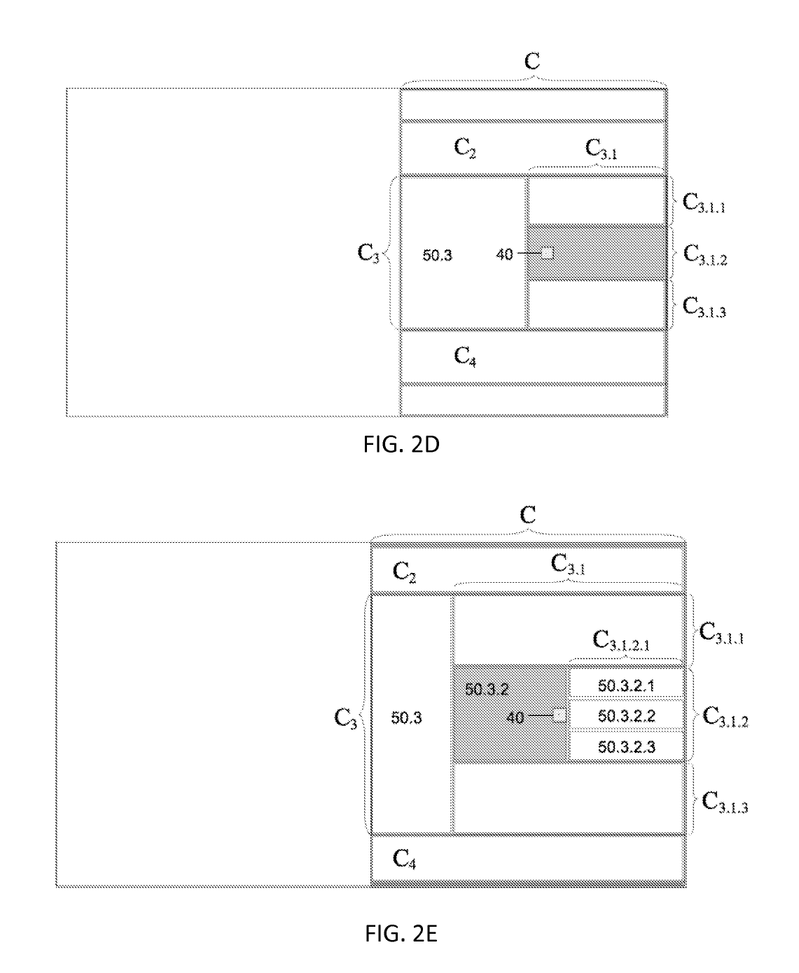

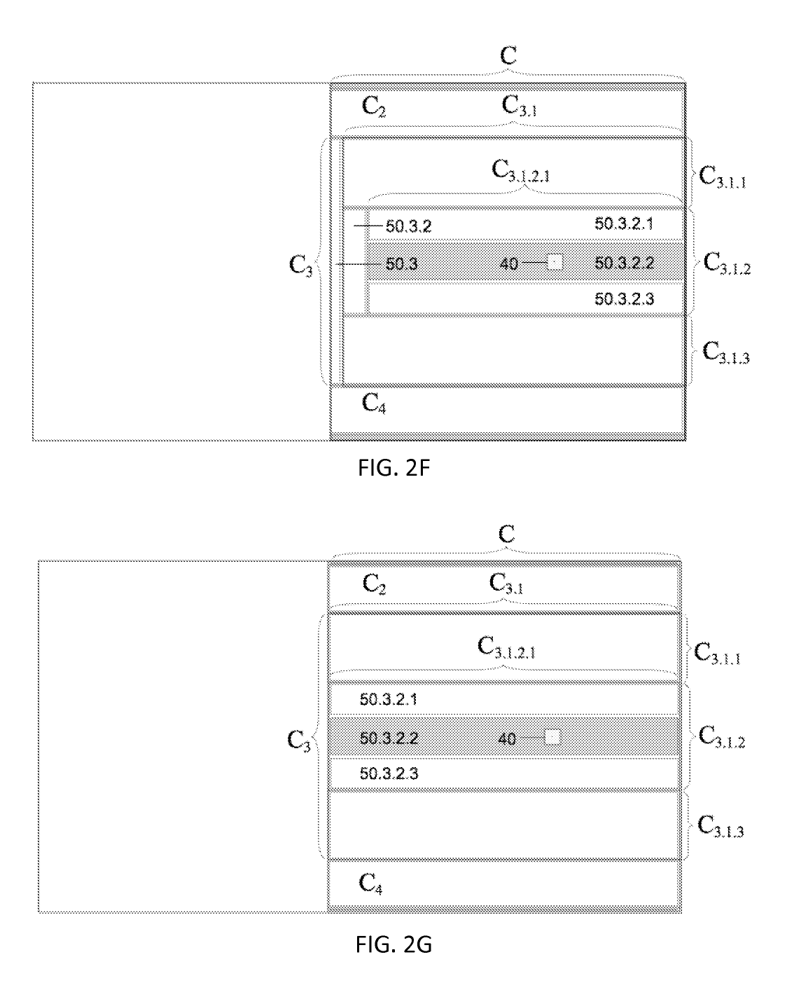

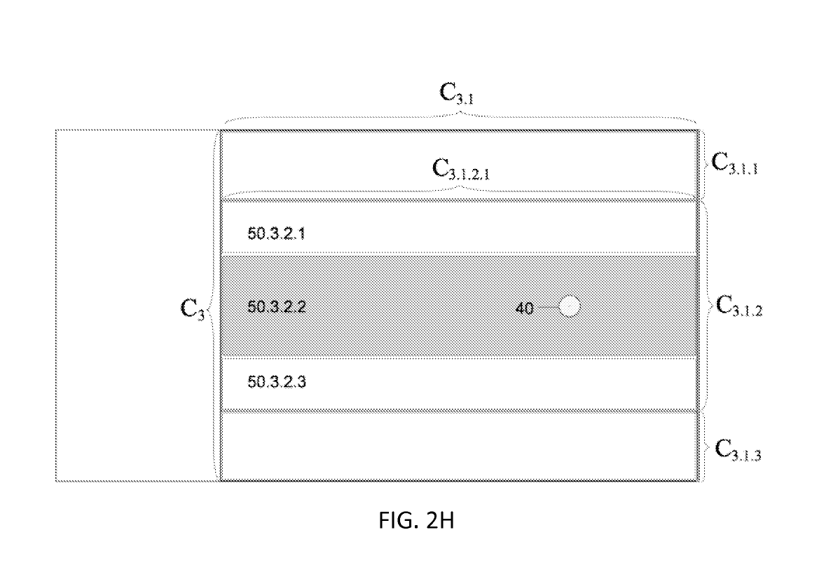

Consider the example illustrated in FIG. 2A. The cluster C contains five further clusters, C₁, . . . , C₅, each consisting of further containers and clusters that are not yet revealed. It is first required for the pointer to enter the interaction area defined above container C before the pointer movement may have an influence on the control claims and therefore expansion of the objects. In FIG. 2B, the pointer enters cluster C and shows that the displayed cluster C₃ is currently the favored cluster since it is the closest to the pointer on the x-y plane. Since there has been no pointer movement in the z-axis to result in a changed pointer to screen distance, no change in control weights or the arrangement of containers was required.

In FIG. 2C, movement in the z-axis causes the width of cluster C to increase, proportionally to the change in z position, and since cluster C₃ is the cluster closest to the pointer in the x-y plane, expansion has caused its children, the container 50.3 and the cluster C_{3.1}, to become visible and also displaying the clusters C_{3.1.1-3} contained within cluster C_{3.1}.

Further movement in the z-axis causes the width of cluster C to grow and for cluster C₃ to display a proportionate increase in display space due to the decreasing control weights of the clusters surrounding C₃. In this example, the reduction occurs in a balanced manner, allowing the center of focus, cluster C₃, to remain in the middle of cluster C.

The control weights are continuously adjusted due to user pointer movement towards the touch surface, as illustrated in FIGS. 2D to 2G, until the pointer reaches the touch surface in FIG. 2H. The circular pointer 40 in FIG. 2H indicates the point of touch.

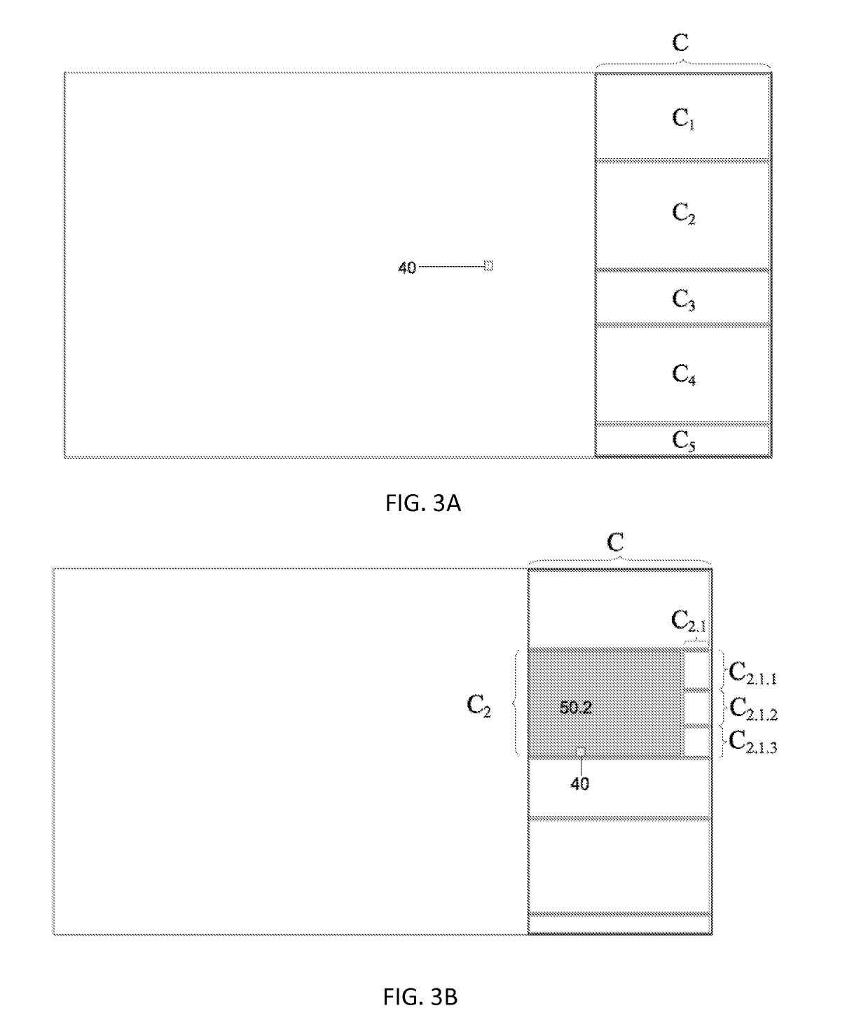

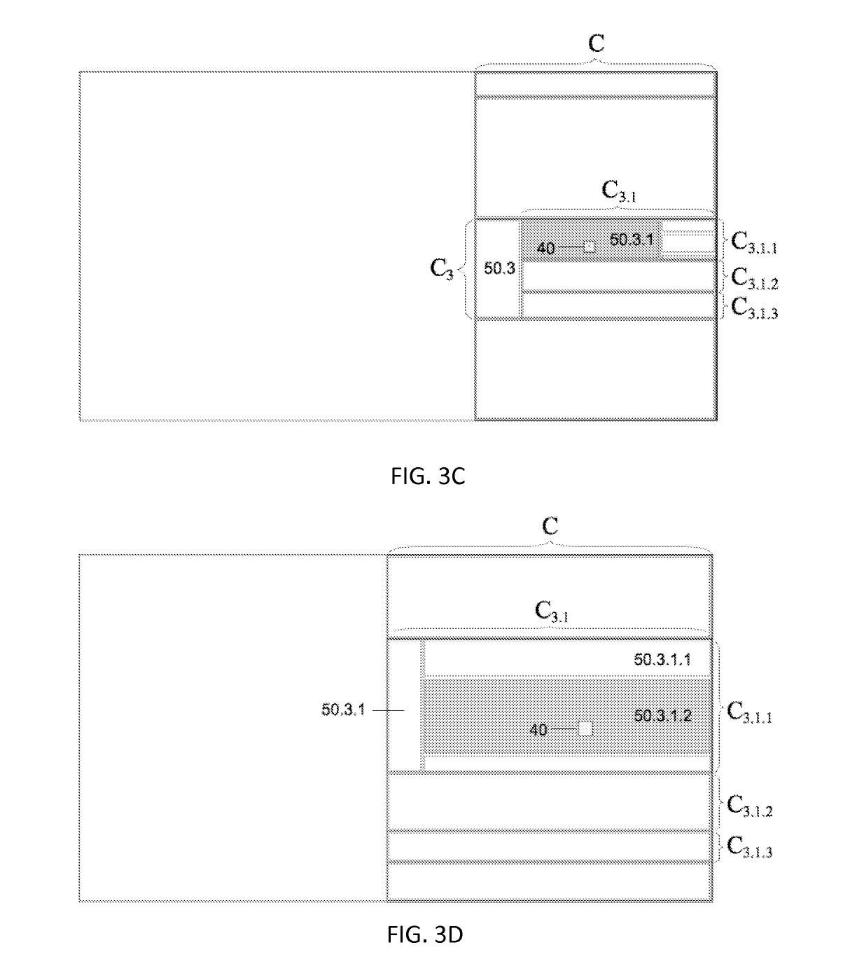

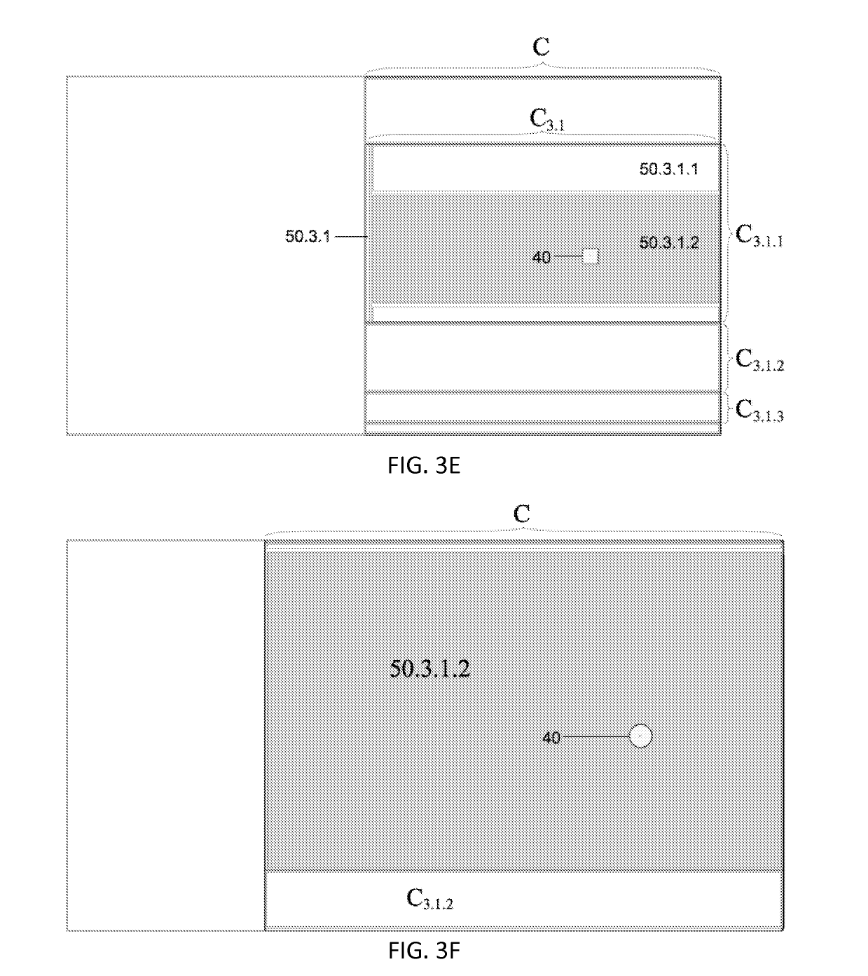

Alternatively, containers may be initialized with unequal control weights based on a priori information. FIG. 3A illustrates such an example. There are five containers, C₁, . . . , C₅, arranged vertically within their parent container C. The control weights assigned to each container ranges from 0.3 to 1.0, where C₅ is assigned the control weight of 0.3 and C₂ is assigned a control weight of 1.0.

As the pointer approaches the surface of a touch device, with the pointer coordinate being closest to container C₂ on the x-y plane as illustrated in FIG. 3B, the parent container's width increases and the contents of C₂ becomes partially visible. In FIG. 3C, the pointer position is now closest to C₃ on the x-y plane and causes expansion of C₂ to cease and the contents of container C₃ becomes visible. As the pointer remains static in the x-y plane, but moves towards the touch device on the z-axis, expansion of container C₃ is displayed in FIGS. 3D to 3F.

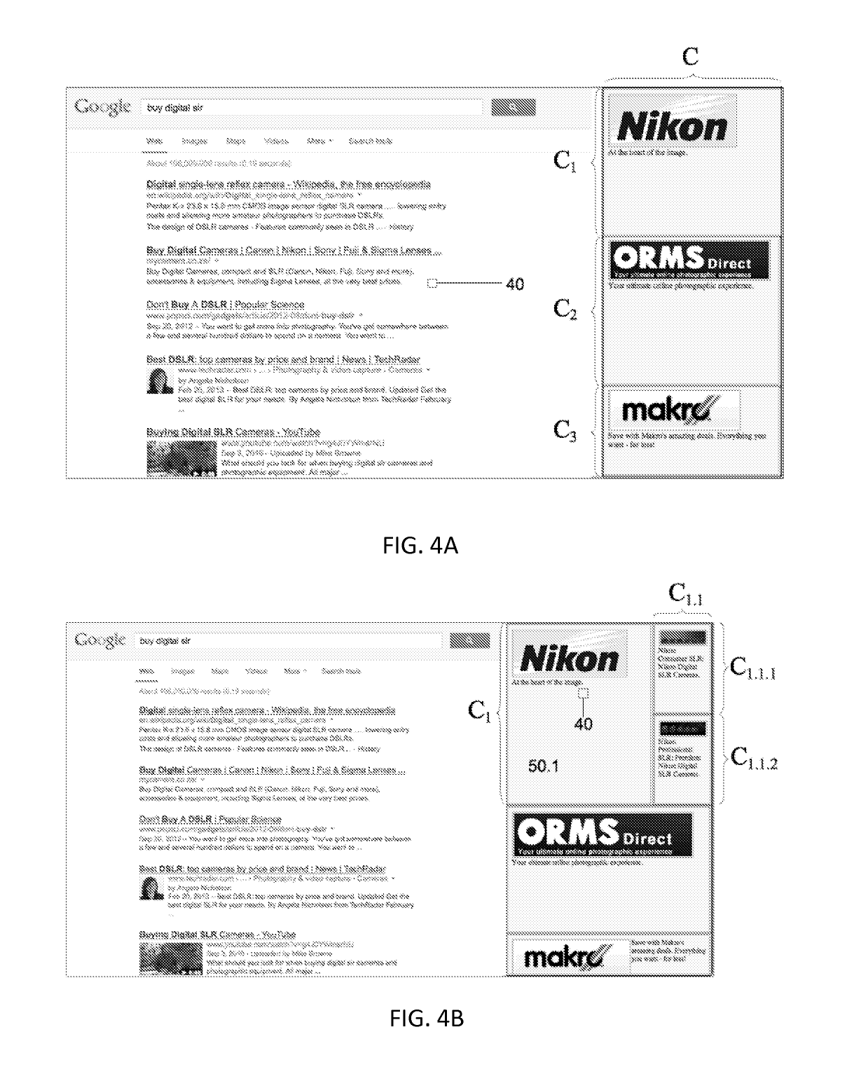

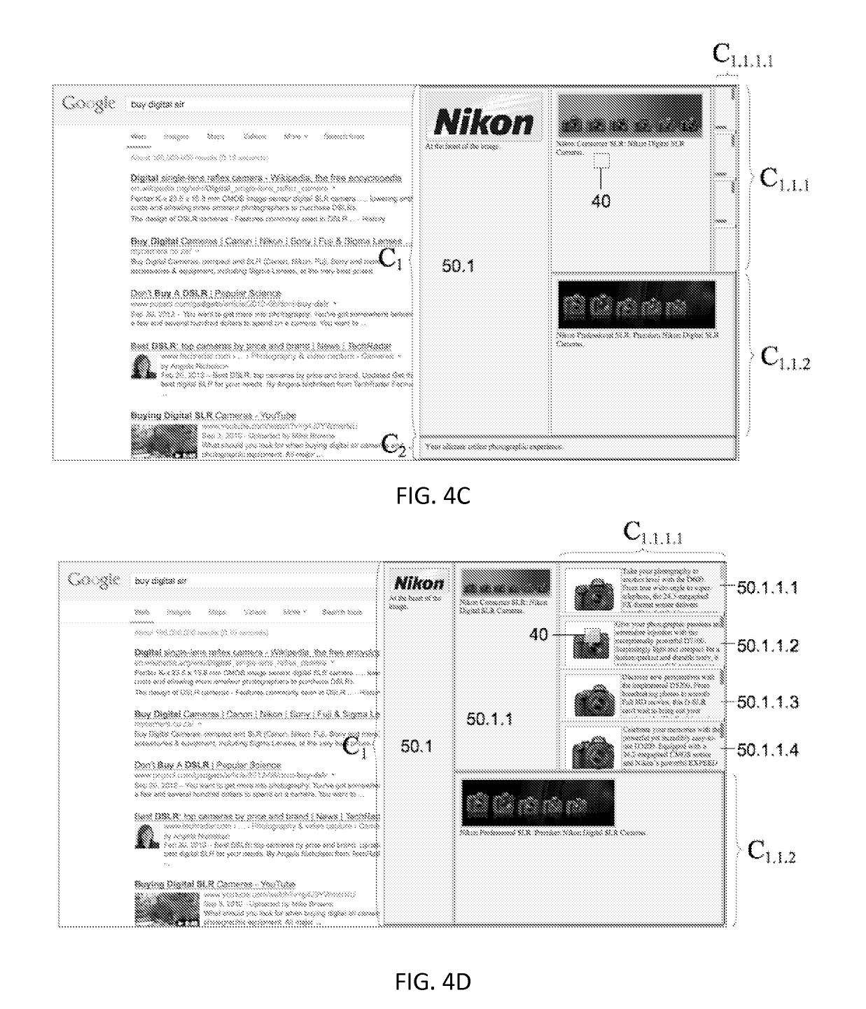

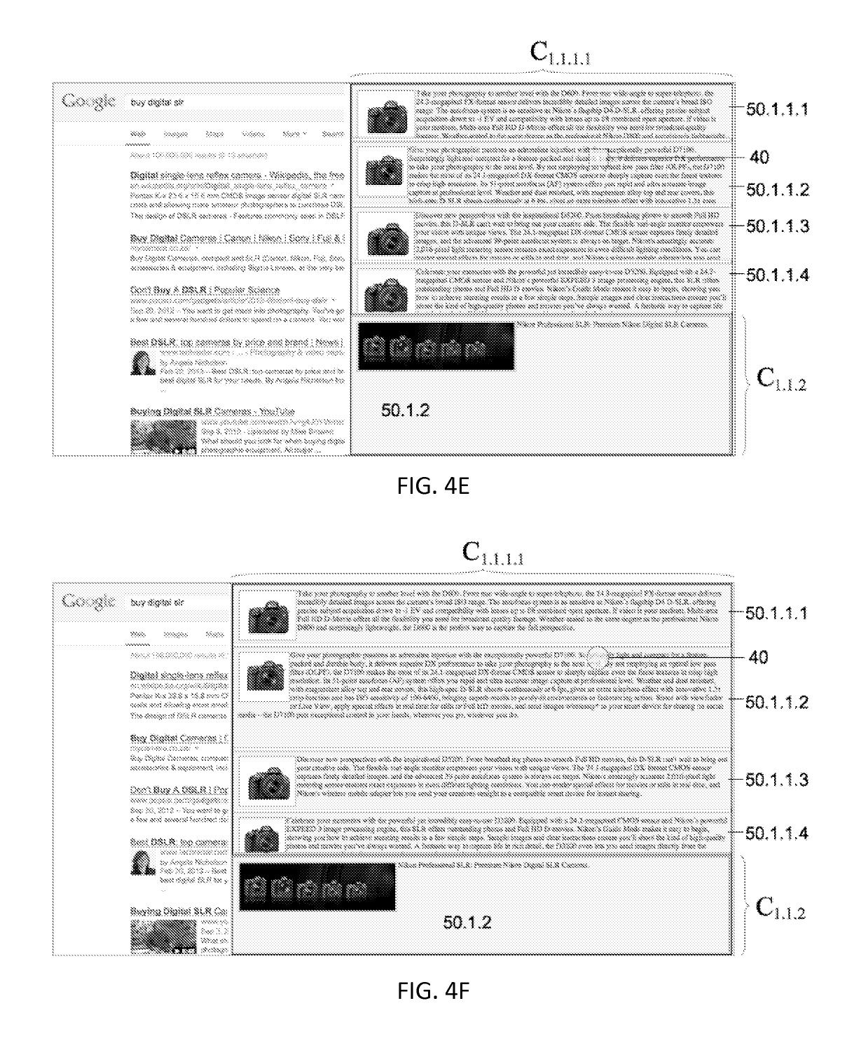

The container structure of the adaptable interactive elements may be used to exhibit a hierarchy of advertisements. Consider the example illustrated in FIG. 4A where a user performed an Internet search query. Advertisements, relevant to the user search, are placed within the containers displayed on the right of the display. In this example search, the user is interested in digital SLR cameras. Three containers are displayed, C₁, . . . , C₃, representing “Nikon”, “ORMSDirect” and “Makro” advertisements, respectively.

In various embodiments, the layout of the content within the advertisements is controlled by using responsive web design (RWD) techniques.

As the pointer approaches the touch device from within the interaction area, the favored cluster, starts to expand as shown in FIG. 4B. Due to the change in global count, calculated from equation 2.2, the control weight of containers C₂ and C₃ are reduced and container C₁ is allocated a proportionately bigger display space as the user expresses more interest in it. As the pointer further approaches the device, and more interest is consequently assumed in container C₁, the contents is expanded to reveal further advertisements within the hierarchical structure of container C₁.

This continues through FIGS. 4C to 4F until the content of container 50.1.1.2 is fully expanded and legible to the user.

When the user selects, through touching or clicking, a specific advertisement in the hierarchy, an associated website may be opened. It should be appreciated that the method allows advertisers to direct prospective customers to specific pages that may be more relevant to the customer's needs.

The advertisements may incorporate e-commerce features, such as product or service price; stock availability; “Add to Cart”, “Check Out” or “Add to Wish-list” buttons or hyperlinks; ratings; reviews and discussion comments, to aid purchasing decisions and potentially increase conversion rates. The advertisements may also incorporate social features, such as sharing, sending, posting, “Tweeting”, “Liking”, “+1”, “Pinning” and “Digging”, to allow users to promote favored content and increasing distribution reach of the promoted content.

It should be appreciated that the method enables the provider of promotional content to track what advertisements the user showed interest in, even if the user did not select an advert. For example, if the user moved the pointer over to the “Nikon” advertisement and then navigate down to a specific camera model, but never clicked, the provider may assume the user is interested in the camera model. If the user moved to the advertisement interactive area and browsed around, the provider may assume the user is interested in a DSL camera but not quite sure what model. If the user never moves the pointer over to the advertisement interactive area, the provider may assume the user is not interested in any of the offered advertisements. These types of information may be analyzed and may be then used to present improved targeted content to the specific user in the future.

It should be appreciated that the method enables providers of a site to keep users on their site longer. Allowing them to collect more accurate information about the consumer's need and the effectiveness of their targeting strategies.

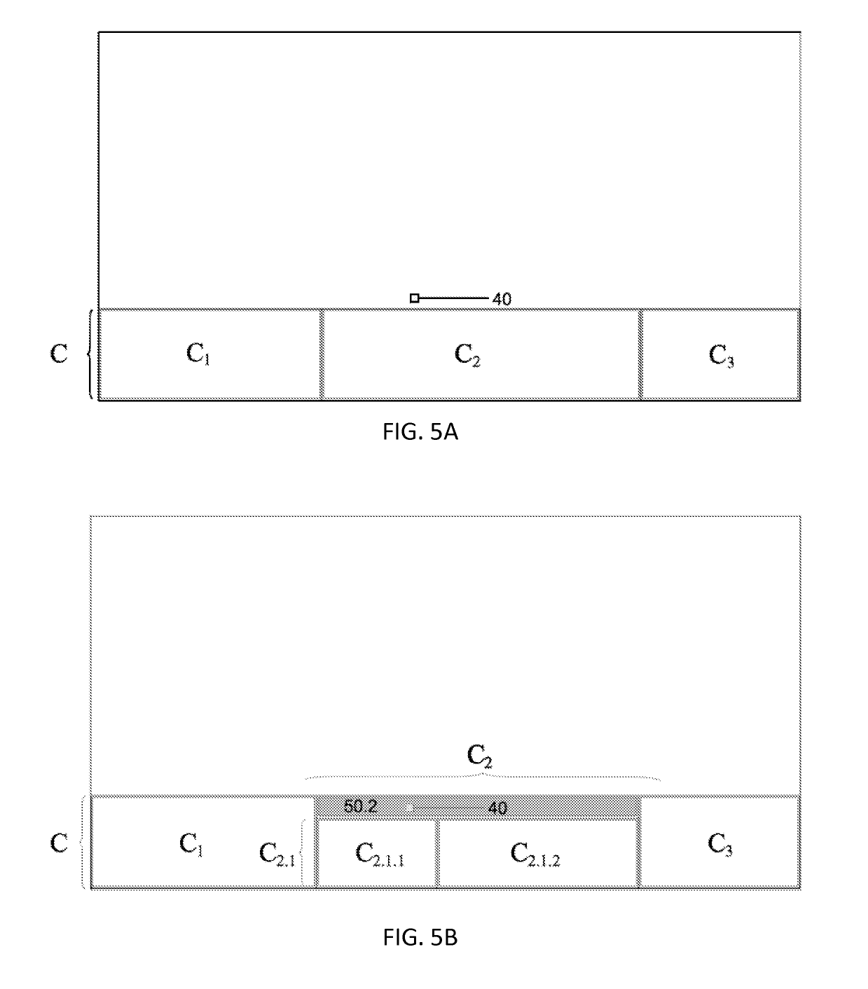

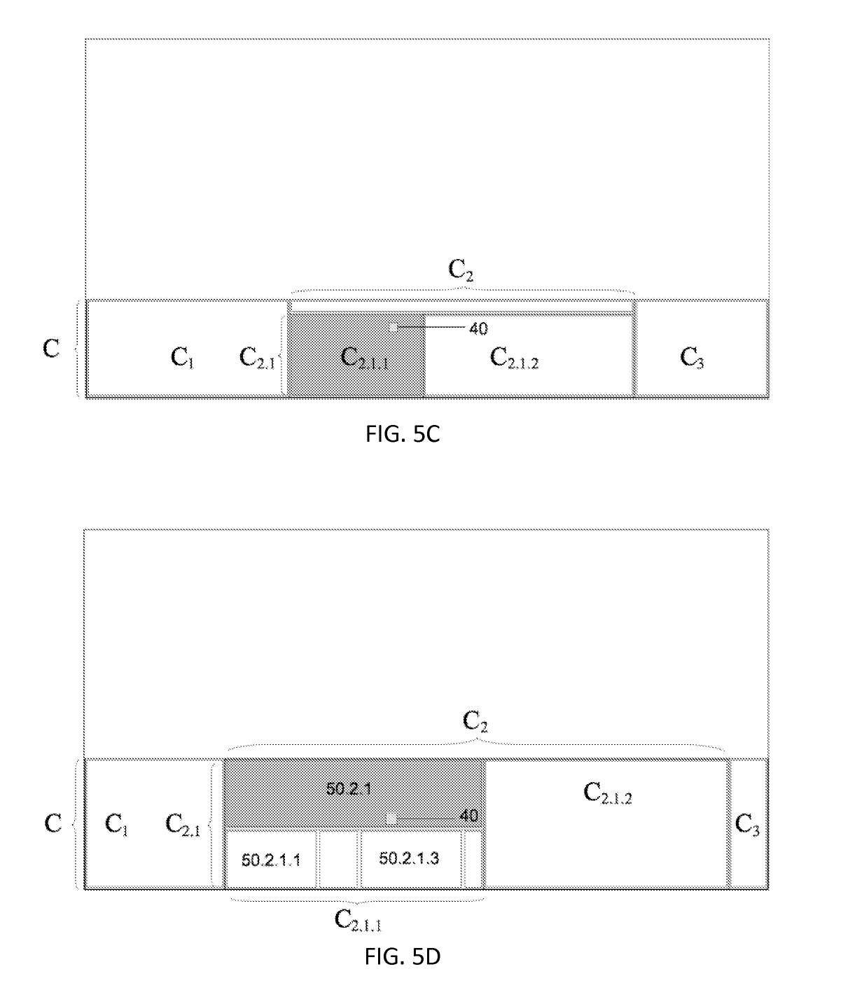

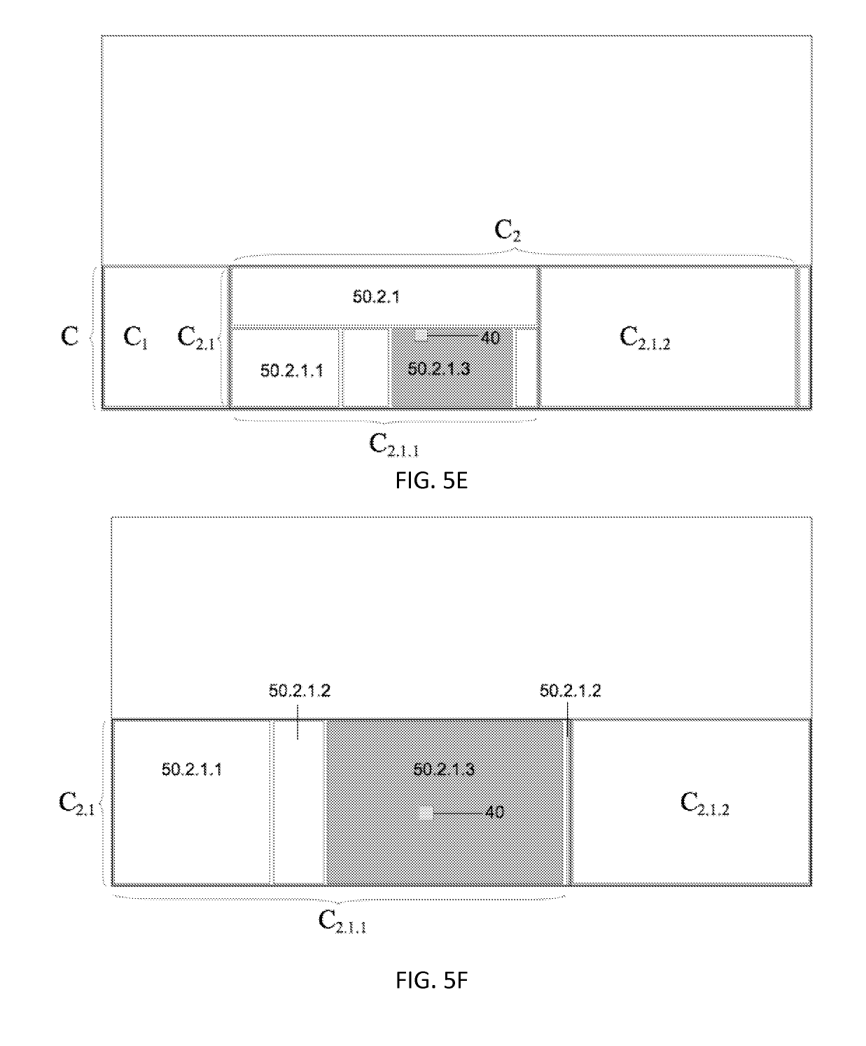

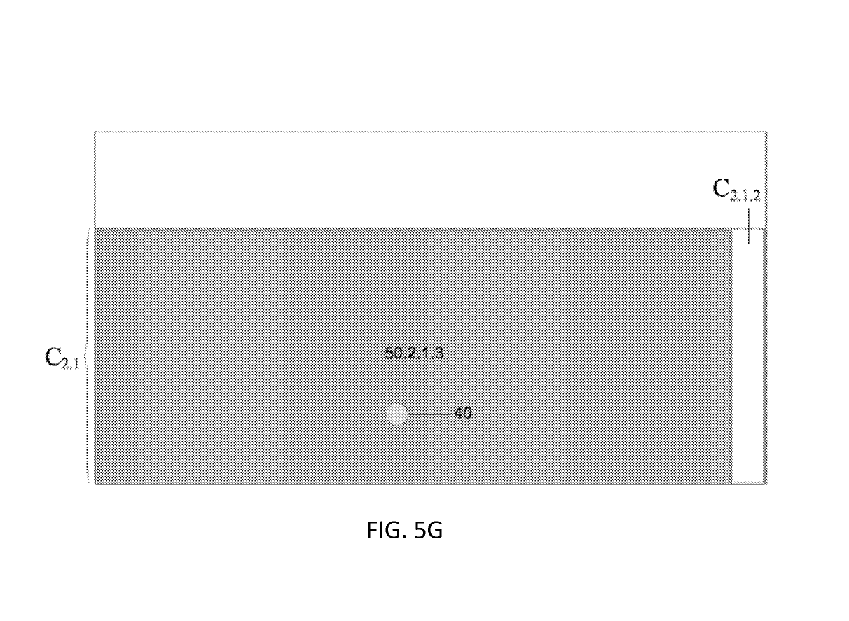

The method allows for the interactive zone to be located at any arbitrary position on the display. The previous examples demonstrated the invention with the interaction area located against the right side of the display. Other useful positions include the left, bottom and top edges of the display. It should also be appreciated that the containers within the AIE clusters may be laid out vertically or horizontally. Therefore, any practical combination of interaction area position and layout orientation is attainable. FIGS. 5A to 5G demonstrate the invention with the interaction area located at the bottom edge of the screen and with the initial containers laid out in a horizontal orientation. Applications of this horizontal layout includes, but is not limited to recommendations displayed at the bottom of an online shopping website (such as Amazon), advertising through banners, possibly displayed at the top of a displayed page, adding useful suggested navigation possibilities at the end of an informative display and providing a menu structure for a website or application.

In FIG. 5A, an example is illustrated where three clusters C₃ are arranged horizontally within cluster C at the bottom of a display. The user pointer 40 is located outside of the interactive area and at the highest possible z-axis value.

The pointer enters the interaction area of cluster C in FIG. 5B, causing expansion of cluster C₂, which is currently the favored cluster duo to its proximity to the pointer 40 on the x-y plane. There has been no pointer movement in the z-axis to result in a changed pointer-to-screen distance and therefore no change in control weights or container arrangements.

As the pointer is moved closer to the display, cluster C starts to increase in size, also resulting in changing control weights and new proportional arrangements. Since cluster C₂ is the cluster closest to the pointer 40 in the x-y plane, expansion has caused the container 50.2 and the cluster C_{2.1} to become visible, also displaying the horizontally arranged clusters C_{2.1.1} and C_{2.1.2} contained within cluster C_{2.1}.

The control weights are again continuously adjusted as the user pointer moves towards the touch surface. In FIG. 5C, cluster C_{2.1} continues to expand with cluster C_{2.1.1} increasing in proportional display size even though the uneven initial control weight assignment deemed cluster C_{2.1.1} to be the smaller of the two clusters in C_{2.1}.

In FIGS. 5D to 5F, the pointer is moved closer to the surface resulting in further control weight and proportional display changes until the pointer reaches the touch surface in FIG. 5G. The circular pointer 40 in FIG. 5G indicates the point of touch.

It should also be appreciated that the interaction area may be of any arbitrary initial size. It does not necessarily need to cover the width or height of the display. This may especially be useful for small display devices, such as mobile phones, tablets and watches.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method for dynamically adapting a plurality of interactive visual elements on the display of an electronic device, comprising the steps of:
determining a user input position of a user input received from an input device of the electronic device;
presenting a plurality of adaptable interactive elements via a display device of the electronic device;
determining a changeable set of adaptable interactive elements in response to the received user input position by interpreting one or more of:
the user input position and contextual relationships between the adaptable interactive elements;
modifying one or more of the adaptable interactive elements in the determined changeable set in response to the received user input to visually distinguish one or more of the adaptable interactive elements in the determined changeable set from other adaptable interactive elements in the plurality of adaptable interactive elements.

2. The method of claim 1, wherein modifying one or more of the adaptable interactive elements in the determined changeable set comprises one or more selected from a group consisting of: changing a state of one or more of the adaptable interface elements in the determined changeable set, changing content displayed by one or more of the adaptable interface elements in the determined changeable set, changing an amount of content displayed by one or more of the adaptable interface elements in the determined changeable set, changing a layout of content displayed by one or more of the adaptable interface elements in the determined changeable set, and any combination thereof.

3. The method of claim 1, wherein determining the changeable set of adaptable interactive elements comprises:
determining a degree of interest of the user in each of the plurality of adaptable interactive elements based at least in part on the user input position; and
selecting one or more adaptable interactive elements for inclusion in the changeable set of adaptable interactive elements based at least in part on the determined degrees of interest.

4. The method of claim 3, wherein modifying one or more of the adaptable interactive elements in the determined changeable set is based at least in part on the determined degrees of interest of the user for adaptable interactive elements in the determined changeable set.

5. The method of claim 1, wherein an adaptable interactive element displays content selected from a group consisting of: text data, audio data, image data, video data, hyperlinks, and any combination thereof.

6. The method of claim 1, wherein an adaptable interactive element displays a single advertisement, a sequence of advertisements, or a hierarchy of advertisements.

7. The method of claim 1, wherein an adaptable interactive element displays one or more selected from a group consisting of: a catalogue of products, a media library, one or more media channels, and one or more application launchers.

8. The method of claim 1, where content displayed by an adaptable interactive element is determined based at least in part on prior interactions by the user with one or more adaptable interactive elements, previously received user inputs, the direction of motion of the user input, and content previously displayed to the user by the adaptable interactive element.

9. The method of claim 1, wherein an adaptable interactive element displays information associated with an online retailer.

10. The method of claim 9, wherein the information associated with an online retailer is selected from a group consisting of: pricing information for an item, availability of the item, a request to purchase the item, a request to include the item in a list associated with the user by the online system, and information describing the item.

11. The method of claim 1, wherein an adaptable interactive element displays one or more interface elements for communicating information to a social networking system.

12. The method of claim 11, wherein the information communicated to the social networking system is selected from a group consisting of: an indication of preference for content displayed to the user, a request to post content displayed to the user to the social networking system, a request to share content displayed to the user with another user via the social networking system, and a request for the social networking system to associate information describing the content displayed to the user with a user profile maintained by the social networking system for the user.

13. The method of claim 1, further comprising:
establishing a joint interaction arena (JIA) as a bounded connected subspace of a control space of the electronic device.

14. The method of claim 1, further comprising:
establishing a segmented threshold (ST) on the boundary of a joint interaction arena (JIA) of a control space of the electronic device where a discrete action or change takes place when the segmented threshold is reached.

15. The method of claim 14, wherein the JIA or ST dynamically changes as one or more of the adaptable interactive elements in the determined changeable set are modified.

16. The method of claim 1, wherein determining the changeable set of adaptable interactive elements in response to the received user input position comprises:
recording a direction of motion of the user input based on one or more previously-received user input positions; and
determining the changeable set of adaptable interactive elements in response to the received user input position by interpreting one or more of:
the user input position, the direction of motion of the user input in relation to positions in which each of the plurality of adaptable interactive elements are presented via the display device, and contextual relationships between the adaptable interactive elements.

17. A method comprising:
displaying a plurality of interactive objects to a user at a plurality of different positions in a graphical user interface;
determining a user input position on the graphical user interface associated with an input device;
selecting an interactive object from the plurality of interactive objects based at least in part on the user input position; and
modifying display of the selected interactive object to visually distinguish the selected interactive object from other interactive objects in the plurality of interactive objects.

18. The method of claim 17, wherein modifying display of the selected interactive object to visually distinguish the selected interactive object from other interactive objects in the plurality of interactive objects comprises:
modifying content presented by the selected interactive object.

19. The method of claim 18, wherein modifying content presented by the selected interactive object comprises:
increasing an amount of content presented by the selected interactive object.

20. The method of claim 18, wherein modifying content presented by the selected interactive object comprises:
retrieving additional content from a source associated with the content presented by the selected interactive object; and
displaying the additional content via the selected interactive object.

21. The method of claim 17, wherein modifying display of the selected interactive object to visually distinguish the selected interactive object from other interactive objects in the plurality of interactive objects comprises:
increasing a size of the selected interactive object relative to sizes of one or more other interactive objects in the plurality of interactive objects.

22. The method of claim 17, wherein modifying display of the selected interactive object to visually distinguish the selected interactive object from other interactive objects in the plurality of interactive objects comprises:
displaying the selected interactive object in a different position of the graphical user interface than a position in the graphical user interface in which the selected interactive object was previously displayed.

23. The method of claim 17, wherein selecting the interactive object from the plurality of interactive objects based at least in part on the user input position and the direction of motion of the user input position comprises:
determining degrees of interest of the user in one or more interactive objects from the plurality of interactive objects based at least in part on the user input position and the direction of motion of the user input position; and
selecting the interactive object from the plurality of interactive objects based at least in part on the determined degrees of interest.

24. The method of claim 17, wherein selecting the interactive object from the plurality of interactive objects based at least in part on the user input position comprises:
determining a direction of motion of the user input position based at least in part on the determined user input position and one or more previously determined user input positions on the graphical user interface; and
selecting the interactive object from the plurality of interactive objects based at least in part on the user input position and the determined direction of motion of the user input position.
